(19) United States
(12) Patent Application Publication
(10) Pub. No.: US 2026/0024392 A1
(43) Pub. Date: Jan. 22, 2026

(54) ELECTRONIC KEY

(71) Applicant: KABUSHIKI KAISHA TOKAI RIKA DENKI SEISAKUSHO, Aichi (JP)

(72) Inventors: Koki USUI, Aichi (JP); Hiroki IMAIZUMI, Aichi (JP); Hideki OTA, Aichi (JP)

(21) Appl. No.: 19/250,488

(22) Filed: Jun. 26, 2025

(30) Foreign Application Priority Data
Jul. 16, 2024 (JP) 2024-113477

(51) Int. Cl. G07C 9/00

(52) U.S. Cl. CPC G07C 9/00944; G07C 9/00309; G07C 2009/00587; G07C 2009/00769; G07C 2009/00984

(57) ABSTRACT

An electronic key includes a case, a cover, and a cover securing mechanism. The case includes a battery receptacle for accommodating a battery. The battery serves as a power supply when performing authentication through wireless communication with a communication peer. The cover is configured to close the battery receptacle. The cover securing mechanism is configured to secure the cover to the case. The cover is removed from the case by operating the cover securing mechanism in two or more different operation directions.

### CROSS-REFERENCE TO RELATED APPLICATIONS

This application is based upon and claims the benefit of priority from Japanese Patent Application No. 2024-113477, filed on Jul. 16, 2024, the entire contents of which are incorporated herein by reference.

### BACKGROUND

### 1. Field

The following description relates to an electronic key configured to be authenticated by a communication peer through wireless communication.

### 2. Description of Related Art

Japanese Patent No. 5652885 discloses a typical portable device that accommodates a battery. The portable device includes a main body having a receptacle for the battery, and a cover that closes the receptacle. The cover is removed from the main body when replacing the battery. In the case of the portable device disclosed in Japanese Patent No. 5652885, the cover may be removed from the main body by rotating the cover in a predetermined direction to disengage claws of the cover from the main body.

### SUMMARY

In this type of portable device, if the cover is easily removable from the main body, a child or an infant may open the cover and extract the battery. Accordingly, there is a need for a structure in which the cover is not easily removed by a child or an infant.

An electronic key in accordance with one general aspect of the present disclosure includes a case, a cover, and a cover securing mechanism. The case includes a battery receptacle for accommodating a battery. The battery serves as a power supply when performing authentication through wireless communication with a communication peer. The cover is configured to close the battery receptacle. The cover securing mechanism is configured to secure the cover to the case. The cover is removed from the case by operating the cover securing mechanism in two or more different operation directions.

With the present disclosure, the cover for the battery is not easily removed by a child.

Other features and aspects will be apparent from the following detailed description, the drawings, and the claims.

### BRIEF DESCRIPTION OF THE DRAWINGS

FIG. 1 is a schematic diagram of an electronic key in accordance with an embodiment.

FIG. 2 is a perspective view of a case with a case watertight portion attached.

FIG. 3 is an exploded perspective view of the electronic key.

FIG. 4 is a perspective view enlarging part of a battery receptacle of the case.

FIG. 5 is a perspective view of the case with a cover attached.

FIG. 6 is a perspective view of the cover as viewed from a front surface.

FIG. 7 is a perspective view of the cover as viewed from a back surface.

FIG. 8 is a cross-sectional view taken along line VIII-VIII shown in FIG. 5.

FIGS. 9A and 9B are cross-sectional views taken along line IX-IX shown in FIG. 5, illustrating an unlocking operation of a first lock of a cover securing mechanism.

FIGS. 10A, 10B, and 10C are diagrams illustrating an unlocking operation of a second lock of the cover securing mechanism.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art. An embodiment of the present disclosure will now be described.

### Electronic Key 1

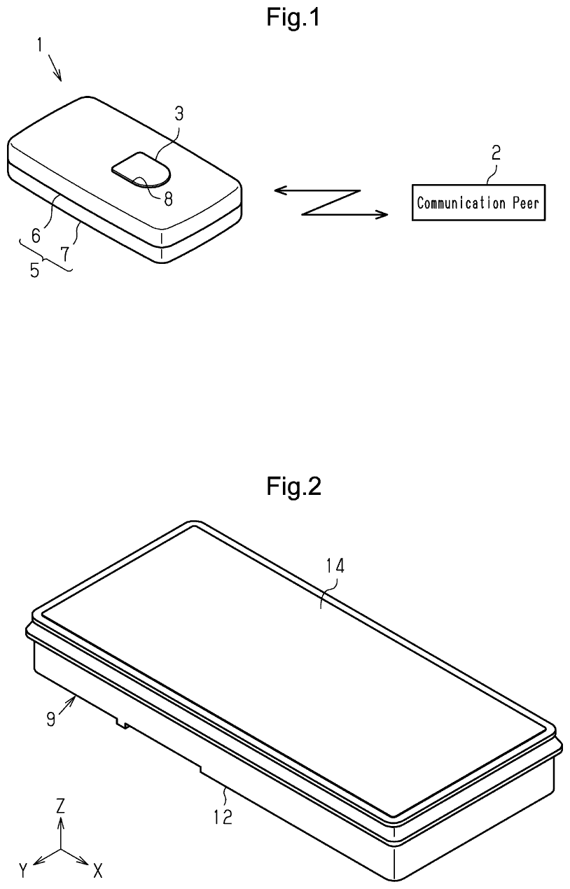

As shown in FIG. 1, an electronic key 1 is configured to be authenticated by a communication peer 2 through wireless communication. When the authentication is successful, operation of the communication peer 2 is permitted or performed. For example, wireless communication for the authentication may be automatically established when the electronic key 1 enters a communication area of the communication peer 2. Alternatively, radio waves for the authentication may be transmitted to the communication peer 2 in response to operation of a button 3 arranged on the electronic key 1. Examples of the communication peer 2 include a vehicle, a residential house, an accommodation facility, a parking facility, a coin-operated locker, or the like.

### Components of Electronic Key 1

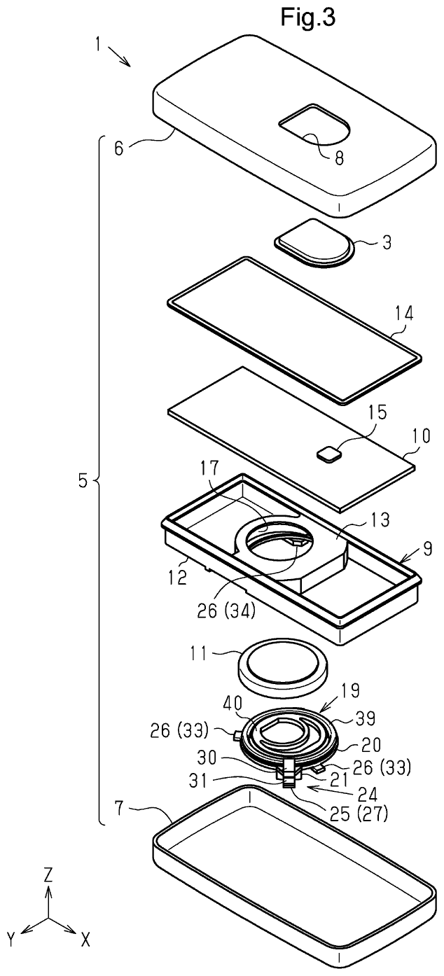

As shown in FIG. 3, the electronic key 1 includes a housing 5 for accommodating components of the electronic key 1. The housing 5 includes an upper housing 6 and a lower housing 7 that are coupled to each other. The button 3 is exposed to the outside through an opening 8 formed in the upper housing 6.

The electronic key 1 includes a case 9 for accommodating electric components of the electronic key 1. For example, the case 9 is an inner case arranged inside the housing 5 to accommodate a substrate 10 on which electric components are mounted. The case 9 is formed from, for example, plastic. A battery 11 serving as a power supply of the electronic key 1 is fitted to the case 9. For example, the battery 11 is a button cell. The case 9 includes a first surface 12 and a second surface 13 at opposite sides in a thickness-wise direction (Z-axis direction in FIG. 3). The first surface 12 is the outer surface of the case 9 in which the battery 11 is disposed. The substrate 10 is disposed in the second surface 13.

Electrical components, such as a control circuit (not shown), a communication circuit (not shown), a communication antenna (not shown), or the like are mounted on the substrate 10. The control circuit includes an integrated circuit (IC) that controls actuation of the electronic key 1. The communication antenna includes, for example, a transmission antenna that transmits radio waves to the communication peer 2, and a reception antenna that receives radio waves from the communication peer 2. The control circuit controls the exchange of radio waves between the communication antennas with the communication circuit.

As shown in FIGS. 2 and 3, the electronic key 1 includes a case watertight portion 14 that protects the second surface 13 of the case 9 from water. For example, the case watertight portion 14 is a flexible rubber seal having a flat plate-like shape. In a state in which the substrate 10 is accommodated in the case 9, the case watertight portion 14 prevents water from entering the case 9 along the edges of the second surface 13 (refer to FIG. 2). When the button 3 is pressed, the operation load is conveyed through elastic deformation of the case watertight portion 14 to a switch 15 formed on the substrate 10.

### Battery Receptacle 17

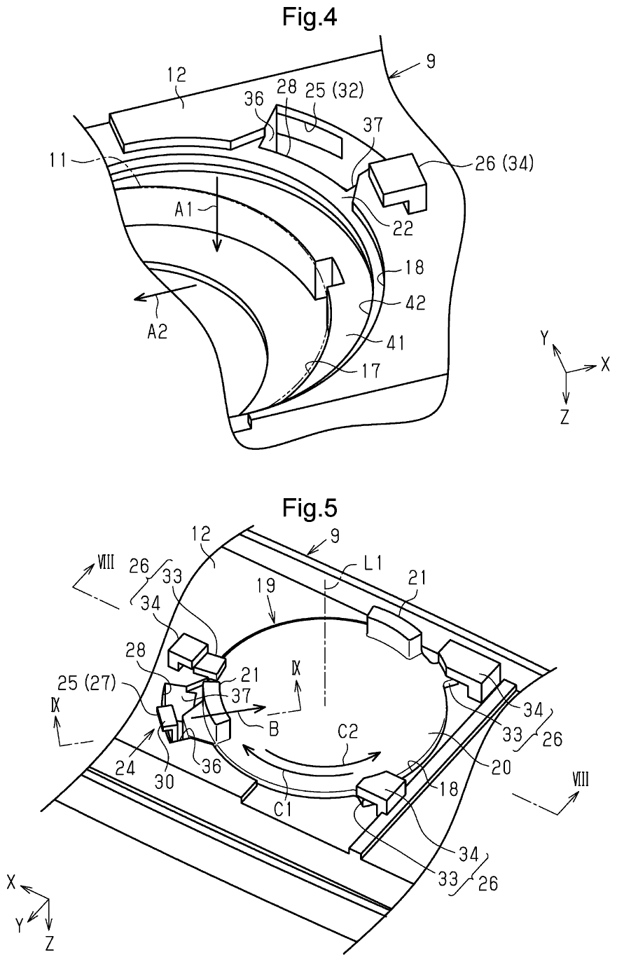

As shown in FIG. 4, the case 9 includes a battery receptacle 17 for accommodating the battery 11. The battery receptacle 17 of the present example is formed as a hole arranged in the first surface 12 of the case 9 to receive the battery 11. For example, the battery 11 is first fitted to the battery receptacle 17 in a fitting direction (indicated by arrow Al in FIG. 4), and then slid in a direction (indicated by arrow A2 in FIG. 4) intersecting the fitting direction. In this manner, the battery 11 comes into electrical contact with the substrate 10. When the battery 11 is accommodated in the battery receptacle 17, the battery 11 is electrically connected to a terminal (not shown) arranged on the substrate 10.

### Cover 19

As shown in FIGS. 3 and 5, the electronic key 1 includes a cover 19 for closing the battery receptacle 17. The cover 19 is attachable to and detachable from the battery receptacle 17 of the case 9. The cover 19 is, for example, rotated about an axis L1 (refer to FIG. 5) of the cover 19 to be fastened and unfastened. In the present example, the cover 19 includes a cover body 20, for example, configured to be disposed in a cover receiving portion 18 arranged at the upper end of the battery receptacle 17. The cover receiving portion 18 has a larger diameter than the battery receptacle 17. The cover body 20 has, for example, a disc-like shape conforming to the shape of the cover receiving portion 18. The front surface of the cover body 20 may include, for example, a design or an instruction indicating the manner in which the battery 11 may be extracted from the battery receptacle 17.

The cover 19 includes a grip portion 21 that may be held by an operator to fasten and unfasten the cover 19. The grip portion 21 is formed as a tab projecting in a height direction of the cover 19. Two grip portions 21 are arranged to oppose each other. That is, the cover 19 includes a pair of grip portions 21. The grip portions 21 may be held by an operator with his/her fingers.

As shown in FIG. 4, the case 9 includes a seating section 22 at the opening of the cover receiving portion 18 to receive a circumferential portion of the cover body 20. The seating section 22 is annular and extends along the opening edge of the cover receiving portion 18. When fastening and unfastening the cover 19, the cover 19 is rotated in a state in which the circumferential portion of the cover 19 is disposed on the seating section 22.

### Cover Securing Mechanism 24

As shown in FIG. 5, the electronic key 1 includes a cover securing mechanism 24 configured to secure the cover 19 to the case 9. The cover securing mechanism 24 includes a structure that requires multiple operations to be performed in two or more different operation directions by an operator to remove the cover 19 from the case 9. The cover securing mechanism 24 includes a first lock 25 and a second lock 26 that are configured to be unlocked in different operation directions. That is, in order to remove the cover 19 from the case 9, the first lock 25 needs to be unlocked in a predetermined unlocking direction, and the second lock 26 needs to be unlocked in another predetermined unlocking direction that differs from the unlocking direction of the first lock 25.

The first lock 25 includes a lock piece 27 formed on the cover 19 and configured to bend in a direction intersecting a rotation direction of the cover 19. In a state in which the cover 19 is attached to the case 9, the lock piece 27 of the present example is fitted to a recessed part 28 formed in a portion of the seating section 22 of the case 9. The recessed part 28 is, for example, connected to the cover receiving portion 18. The first lock 25 includes a snap-fit structure that engages with its counterpart by elastic deformation of the lock piece 27.

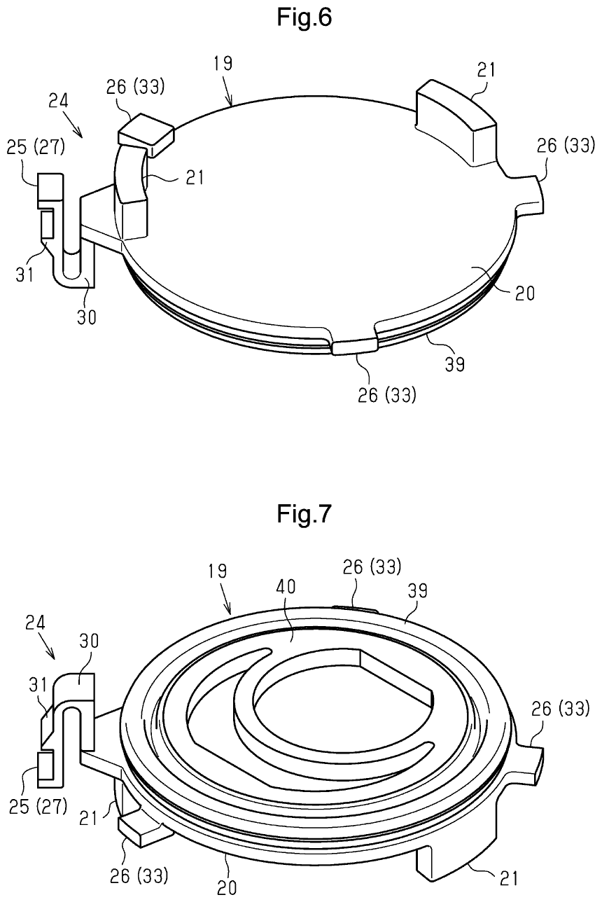

As shown in FIGS. 6 and 7, the lock piece 27 includes, for example, a substantially U-shaped lock piece body 30 and a protrusion 31 formed on a side surface of the lock piece body 30. The lock piece body 30 has a basal end fixed to the cover body 20. The protrusion 31 is configured to engage with an engagement section 32 (refer to FIG. 4) formed in a side wall of the recessed part 28. For example, the engagement section 32 is a through hole. In this manner, the first lock 25 locks the cover 19 to the case 9 through engagement of the lock piece 27 with the case 9.

As shown in FIG. 5, the second lock 26 locks the cover 19 to the case 9 through engagement of an end piece 33 of the cover 19 with the case 9. Such engagement is obtained by rotation of the cover 19. For example, the end piece 33 of the present example is a lug projecting radially outward from the circumference of the cover body 20. Multiple end pieces 33 (in the present example, three) are arranged at predetermined intervals about the axis L1 of the cover 19. When the end pieces 33 are engaged with engagement projections 34 formed along the edge of the cover receiving portion 18 of the case 9, the cover 19 is restricted from moving in a thickness direction (Z-axis direction shown in FIG. 5).

When removing the cover 19 from the case 9, the first lock 25 is unlocked by disengaging the lock piece 27 from the case 9, and the second lock 26 is unlocked by rotating the cover 19 to disengage the end pieces 33 from the case 9. In this manner, multiple operations, namely, a first operation and a second operation, need to be performed to remove the cover 19. The first operation pulls the lock piece 27 toward the center of the cover 19 (direction indicated by arrow B in FIG. 5) to disengage the lock piece 27 from the engagement section 32. The second operation rotates the cover 19 in a direction in which the cover 19 is unfastened (direction indicated by arrow C1 in FIG. 5) to disengage the end pieces 33 from the engagement projections 34.

### Cover-Fastening-Operation Stopper 36

As shown in FIGS. 4 and 5, the cover securing mechanism 24 includes a cover-fastening-operation stopper 36 (stopper 36) that stops rotation of the cover 19 in a direction in which the cover 19 is fastened (direction indicated by arrow C2 in FIG. 5) at a position where the first lock 25 and the second lock 26 are locked. The recessed part 28, which is configured to receive the lock piece 27, includes two wall surfaces opposing each other in the rotation direction of the cover 19. The stopper 36 corresponds to one of the two wall surfaces of the recessed part 28 that is located at the advancing side in the direction in which the cover 19 is fastened. When the lock piece 27 comes into contact with the stopper 36, the cover 19 is restricted from rotating any farther in the direction in which the cover 19 is fastened. When the lock piece 27 is in contact with the stopper 36, the end pieces 33 are located below the engagement projections 34. Therefore, the end pieces 33 are positioned relative to the engagement projections 34.

### Cover-Unfastening-Operation Stopper 37

As shown in FIG. 5, the cover securing mechanism 24 includes a cover-unfastening-operation stopper 37 (stopper 37) that stops rotation of the cover 19 in a direction in which the cover 19 is unfastened (direction indicated by arrow C1 in FIG. 5) at a position where the first lock 25 and the second lock 26 are unlocked. The recessed part 28, which is configured to receive the lock piece 27, includes the two wall surfaces opposing each other in the rotation direction of the cover 19. The stopper 37 corresponds to one of the two wall surfaces of the recessed part 28 that is located at the advancing side in the direction in which the cover 19 is unfastened. When the lock piece 27 comes into contact with the stopper 37, the cover 19 is restricted from rotating any farther in the direction in which the cover 19 is unfastened. When the lock piece 27 is in contact with the stopper 37, the end pieces 33 are released from the engagement projections 34.

### Cover Watertight Portion 39

As shown in FIGS. 6 and 7, the electronic key 1 includes a cover watertight portion 39 that prevents entry of water between the cover 19 and the battery receptacle 17 in a state in which the battery receptacle 17 is closed by the cover 19. The cover watertight portion 39 is ring-shaped and extends along the circumferential portion of the cover body 20. Preferably, the cover watertight portion 39 is, for example, a ring-shaped rubber seal. The cover watertight portion 39 is fitted onto an annular back surface projection 40 arranged on a back surface of the cover body 20. The cover watertight portion 39 may be formed on the cover 19 by insert molding. Alternatively, the cover watertight portion 39 may be retrofitted to the cover 19.

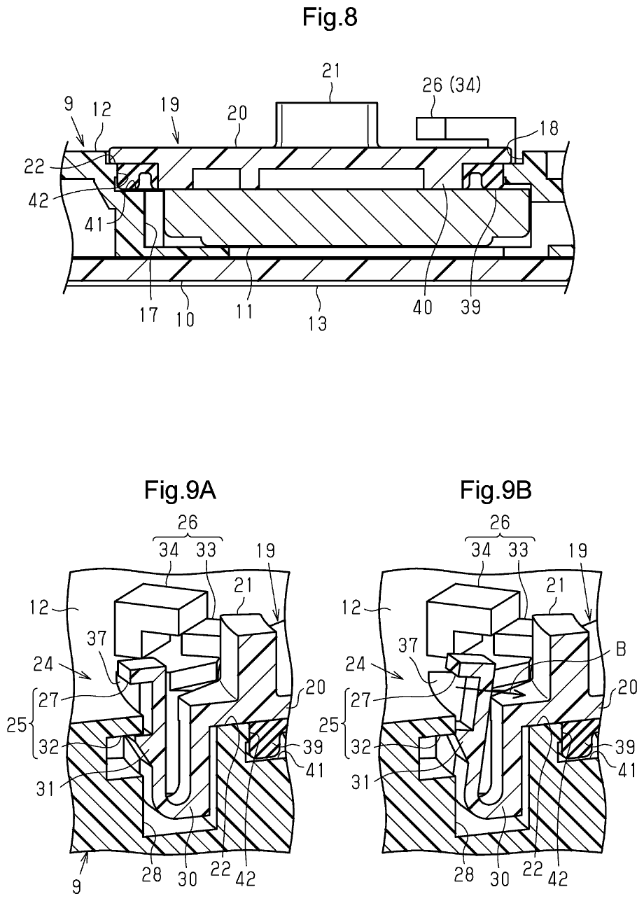

As shown in FIG. 8, the cover watertight portion 39 is arranged such that the cover watertight portion 39 abut the side surface of the back surface projection 40 and the back surface of the circumferential portion of the cover body 20. In a state in which the battery receptacle 17 is closed by the cover 19, the cover watertight portion 39 is disposed on a stepped portion 41 located at the opening of the battery receptacle 17. The cover watertight portion 39 has a lip-like cross-sectional shape that opposes the bottom surface of the stepped portion 41. When the cover watertight portion 39 is elastically deformed and firmly forced against a wall surface 42 of the stepped portion 41, the cover watertight portion 39 ensures the seal between the wall surface 42 and the side surface of the cover watertight portion 39 contacting the wall surface 42.

### Operation of the Embodiment

The operation of the electronic key 1 in accordance with the present embodiment will now be described.

As shown in FIGS. 9A and 9B, when removing the cover 19 from the case 9, an operator first applies an operation load to the lock piece 27 in a tilting direction (indicated by arrow B in FIG. 9B) to elastically deform the lock piece 27. This releases the protrusion 31 of the lock piece 27 from the engagement section 32. That is, in order to remove the cover 19 from the case 9, the first operation is first performed to tilt the lock piece 27 toward the center (axis L1) of the cover 19. This unlocks the first lock 25 of the cover securing mechanism 24.

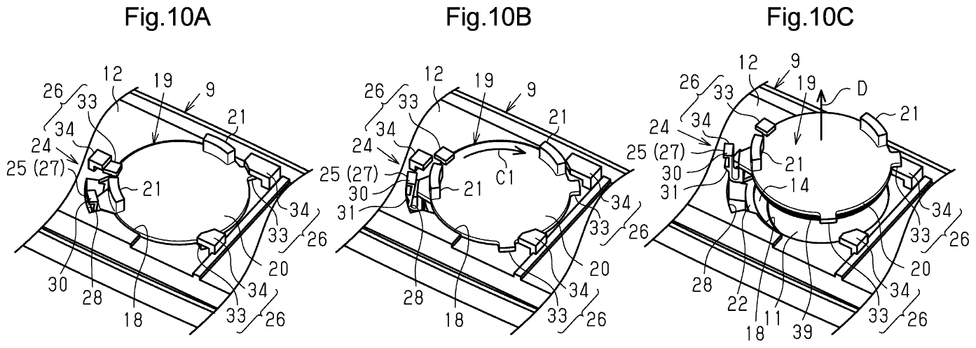

Then, as shown in FIG. 10A and 10B, in a state in which the protrusion 31 of the lock piece 27 is released from the engagement section 32 of the case 9, the cover 19 is rotated in the direction in which the cover 19 is unfastened (direction indicated by arrow C1 in FIG. 10B). That is, after the protrusion 31 of the lock piece 27 is released from the engagement section 32 of the case 9, the second operation is performed to rotate the cover 19 in the unfastening direction. In this case, the rotation of the cover 19 in the unfastening direction is permitted until the lock piece 27 of the cover 19 comes into contact with the stopper 37 of the case 9.

When the cover 19 is rotated in the unfastening direction, the end pieces 33 of the cover 19 are released from the engagement projections 34 of the case 9. This unlocks the second lock 26 of the cover securing mechanism 24. In the present example, the first operation, which disengages the lock piece 27 of the cover 19 from the engagement section 32 of the case 9, and the second operation, which rotates the cover 19 to disengage the end pieces 33 of the cover 19 from the engagement projections 34, are consecutively performed to unlock the cover securing mechanism 24. That is, the cover 19 becomes removable when the first operation and the second operation are performed in different operation directions to unlock the cover securing mechanism 24.

As shown in FIG. 10C, after the cover securing mechanism 24 is unlocked, the cover 19 may be lifted toward the operator (direction indicated by arrow D in FIG. 10C) and removed from the case 9. In this case, the battery 11 may be extracted through the opening of the battery receptacle 17 for replacement.

As described above, in the present example, in order to remove the cover 19 from the case 9, the first operation is performed in one direction to tilt the lock piece 27 of the cover 19, and the second operation is performed in another direction to rotate the cover 19 in which the cover 19 is unfastened. Specifically, when removing the cover 19 from the case 9, the cover 19 needs to be rotated in a state in which the snap-fit of the first lock 25 is disengaged. In this manner, multiple operations (in the present example, two operations) need to be performed in different operation directions to remove the cover 19 from the case 9. Therefore, the cover 19 is not easily removed from the case 9 by an infant. This contributes to prevention of accidental ingestion of the battery 11 by an infant.

### Advantages of the Embodiment

The electronic key 1 in accordance with the above embodiment has the following advantages.
(1) The electronic key 1 includes the case 9 and the cover 19. The case 9 includes the battery receptacle 17 for accommodating the battery 11. The battery 11 serves as a power supply when performing authentication through wireless communication with the communication peer 2. The cover 19 is configured to close the battery receptacle 17. The electronic key 1 includes the cover securing mechanism 24 configured to secure the cover 19 to the case 9. The cover 19 is removed from the case 9 by operating the cover securing mechanism 24 in two or more different operation directions.

With this structure, multiple operations need to be performed in different operation directions to remove the cover 19 from the battery receptacle 17. Accordingly, it is difficult for a child or an infant to remove the cover 19. Therefore, the cover 19 for the battery is not easily removable by a child.
(2) The cover 19 is rotated about the axis LI of the cover 19 to be fastened and unfastened. The cover securing mechanism 24 includes the first lock 25 and the second lock 26. The first lock 25 locks the cover 19 to the case 9 through engagement of the lock piece 27 formed on the cover 19 with the case 9. The lock piece 27 is configured to bend in a direction intersecting the rotation direction of the cover 19. The second lock 26 locks the cover 19 to the case 9 through engagement of the end pieces 33 of the cover 19 with the case 9. Such engagement is obtained by rotation of the cover 19. When removing the cover 19 from the case 9, the first lock 25 is unlocked by disengaging the lock piece 27 from the case 9, and the second lock 26 is unlocked by rotating the cover 19 to disengage the end pieces 33 from the case 9.

With this structure, in order to remove the cover 19, the lock piece 27 of the first lock 25 needs to be tilted in a direction intersecting the rotation operation of the cover 19, and the cover 19 needs to be rotated. Accordingly, removal of the cover 19 is a complex action for a child or an infant. This further contributes to prevention of removal of the cover 19 by a child.
(3) The cover securing mechanism 24 includes the cover-fastening-operation stopper 36 that stops rotation of the cover 19 in the direction in which the cover 19 is fastened at a position where the first lock 25 and the second lock 26 are locked. With this structure, when rotating the cover 19 to fasten the cover 19 to the battery receptacle 17, the rotation of the cover 19 is stopped at the position where the first lock 25 and the second lock 26 of the cover securing mechanism 24 are locked. Therefore, the cover 19 is readily arranged at an optimal position when fastening the cover 19 to the battery receptacle 17.
(4) The cover securing mechanism 24 includes the cover-unfastening-operation stopper 37 that stops rotation of the cover 19 in the direction in which the cover 19 is unfastened at a position where the first lock 25 and the second lock 26 are unlocked. With this structure, when rotating the cover 19 to unfasten the cover 19 from the battery receptacle 17, the rotation of the cover 19 is stopped at the position where the first lock 25 and the second lock 26 of the cover securing mechanism 24 are unlocked. Therefore, the cover 19 is readily arranged at an optimal position when unfastening the cover 19 from the battery receptacle 17.
(5) The electronic key 1 includes the cover watertight portion 39 that prevents entry of water between the cover 19 and the battery receptacle 17 in a state in which the battery receptacle 17 is closed by the cover 19. With this structure, the cover watertight portion 39 arranged between the battery receptacle 17 and the cover 19 protects the battery 11 from water.
(6) The case 9 includes the first surface 12 in which the battery receptacle 17 is formed, and the second surface 13 located at a side opposite to the first surface 12. The electronic key 1 includes the case watertight portion 14 that protects the second surface 13 from water when attached to the second surface 13. With this structure, the case watertight portion 14 is arranged on the second surface 13 of the case 9. This prevents entry of water or the like to the second surface 13 of the case 9. Accordingly, when electric components are accommodated in the case 9, the case watertight portion 14 protects the electric component from water.
(7) The cover 19 includes the grip portion 21 that may be held by an operator to fasten and unfasten the cover 19. With this structure, the cover 19 may be easily held with the grip portion 21 arranged on the cover 19. This facilitates fastening and unfastening of the cover 19.

### Other Embodiments

The above embodiment may be modified as follows. The above embodiment and the following modifications can be combined as long as they remain technically consistent with each other.

The lock piece 27 of the first lock 25 does not have to be fitted into the recessed part 28 formed in the case 9. When the recessed part 28 is omitted from the case 9, for example, the lock piece 27 of the first lock 25 may be exposed from the surface of the case 9.

The engagement projection 34 of the second lock 26 may overlap the cover receiving portion 18. In this case, it is preferred that the cover 19 includes a slit, so that the engagement projection 34 does not interfere with the cover 19 when fitting the cover 19 to the cover receiving portion 18.

The cover 19 does not have to be attachable to and detachable from the case 9, and may be attachable to and detachable from the housing 5.

The case watertight portion 14 may be, for example, a ring-shaped seal.

The cover-fastening-operation stopper 36 and the cover-unfastening-operation stopper 37 are not limited to the wall surfaces of the recessed part 28, and may be, for example, wall surfaces of a projection arranged on the case 9.

The cover-fastening-operation stopper 36 and the cover-unfastening-operation stopper 37 do not have to contact the lock piece 27 of the cover 19, and may contact any part of the cover 19.

The grip portion 21 is not limited to a tab, and may be a groove.

The operation directions of the multiple operations for removing the cover 19 from the case 9 may be any combination of directions as long as the operation directions are different from one another.

The multiple operations for removing the cover 19 from the case 9 do not have to be performed together, and may be performed independently from each other.

The electronic key 1 may be, for example, a key fob.

The electronic key 1 may be, for example, a high-performance mobile phone having a key functionality.

The present disclosure described in accordance with the examples is to be considered as illustrative and not restrictive. The present disclosure includes various modified examples and modifications within the scope of equivalence. Additionally, various combinations and modes and one, more, or less of these elements in other combinations and forms are included in the range and conceptual scope of the present disclosure.

The present description includes following embodiment modes. Reference characters are assigned to the components in the embodiment modes to facilitate understanding without limiting the scope of the present disclosure.

### Clause 1

An electronic key (1), including:
a case (9) including a battery receptacle (17) for accommodating a battery (11), the battery serving as a power supply when performing authentication through wireless communication with a communication peer (2);
a cover (19) configured to cover the battery receptacle and attachable to and detachable from the case, the cover being movable between a fastened position at which the cover is fastened to the case and an unfastened position at which the cover is detachable from the case; and
a lock member (27) restricting movement of the cover at the fastened position,
in which the lock member is configured to move in a direction intersecting a movement direction of the cover to release the restriction on movement of the cover.

### Clause 2

The electronic key according to clause 1, in which
the cover is rotatable about an axis (L1) of the cover between the fastened position and the unfastened position,
the cover includes one or more end pieces (33) formed on the cover,
at the fastened position, the one or more end pieces engage with the case to restrict movement of the cover in an axial direction (thickness-wise direction) of the cover,
the lock member includes a lock piece formed on the cover,
the lock piece is configured to engage with the case to restrict rotation of the cover, and
the lock piece is configured to bend toward the axis of the cover (in a direction intersecting a rotation direction (C1 and C2) of the cover) to release the restriction on movement of the cover.

### Clause 3

The electronic key according to clause 2, in which the cover is removed from the case by rotating the cover from the fastened position to the unfastened position in a state in which the lock piece is bent.

### Clause 4

The electronic key according to clause 3, in which
the case includes a seat portion (22) for seating the cover, and a recessed part (28) formed in the seating section to receive the lock piece; and
the recessed part includes two wall surfaces (36 and 37) arranged in the rotation direction of the cover, so that the cover is rotatable within a predetermined angle range in a state in which the lock piece is bent.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An electronic key, comprising:
a case including a battery receptacle for accommodating a battery, the battery serving as a power supply when performing authentication through wireless communication with a communication peer;
a cover configured to close the battery receptacle; and
a cover securing mechanism configured to secure the cover to the case,
wherein the cover is removed from the case by operating the cover securing mechanism in two or more different operation directions.

2. The electronic key according to claim 1, wherein
the cover is rotated about an axis of the cover to be fastened and unfastened,
the cover securing mechanism includes
a first lock configured to lock the cover to the case through engagement of a lock piece formed on the cover with the case, the lock piece being configured to bend in a direction intersecting a rotation direction of the cover; and
a second lock configured to lock the cover to the case through engagement of an end piece of the cover with the case, the engagement being obtained by rotation of the cover, and
when removing the cover from the case, the first lock is unlocked by disengaging the lock piece from the case, and the second lock is unlocked by rotating the cover to disengage the end piece from the case.

3. The electronic key according to claim 2, wherein the cover securing mechanism includes a cover-fastening-operation stopper configured to stop rotation of the cover in a direction in which the cover is fastened at a position where the first lock and the second lock are locked.

4. The electronic key according to claim 2, wherein the cover securing mechanism includes a cover-unfastening-operation stopper configured to stop rotation of the cover in a direction in which the cover is unfastened at a position where the first lock and the second lock are unlocked.

5. The electronic key according to claim 1, further comprising a cover watertight portion configured to prevent entry of water between the cover and the battery receptacle in a state in which the battery receptacle is closed by the cover.

6. The electronic key according to claim 1, wherein the case includes a first surface in which the battery receptacle is formed, and a second surface located at a side opposite to the first surface, and
the electronic key further comprises a case watertight portion configured to protect the second surface from water when attached to the second surface.

7. The electronic key according to claim 1, wherein the cover includes a grip portion configured to be held by an operator to fasten and unfasten the cover.
